(19) United States
(12) Patent Application Publication
(10) Pub. No.: US 2026/0354345 A1
(43) Pub. Date: Nov. 12, 2026

(54) SUIT FOR PET

(71) Applicant: Sang-Yeon HAN, Seoul (KR)

(72) Inventor: Sang-Yeon HAN, Seoul (KR)

(21) Appl. No.: 19/126,010

(22) PCT Filed: Mar. 7, 2024
(86) PCT No.: PCT/KR2024/002963

§ 371 Date: Apr. 30, 2025

(30) Foreign Application Priority Data
Mar. 8, 2023 (KR) 10-2023-0030676

(51) Int. Cl. A01K 13/00

(52) U.S. Cl. CPC A01K 13/006

(57) ABSTRACT

The present invention relates to a suit for a pet and, in particular, to a suit for a pet, comprising: a torso suit wrapping the torso of the pet so as to be conveniently worn and taken off since the legs of the pet can be easily inserted therein, and to not restrict walking of the pet; and leg suits which are made of a soft material, which are coupled to the torso suit, and into which the legs of the pet are inserted, wherein the leg suits are formed by coupling, on a band-shape fabric, front and rear ends positioned at areas below the ankle joints of the pet, so as to form a shape of wrapping up to lower portions adjacent to the ankle joints of the pet, and covers the femoral regions of the pet by gradually spreading toward the torso suit from portions at which the ankle joints of the pet are positioned.

### DESCRIPTION

### Technical Field

The present disclosure relates to a pet suit and, more particularly, to a pet suit that is easy to put on a pet to protect the pet from external factors when going outdoors.

### Background Art

Recently, as living standards have improved and families have become more nuclear, many people have pets such as dogs and cats as companions to improve their quality of life by relieving loneliness and promoting emotional stability. People feel a sense of kinship and connection with their pets as they consider their pets as family members rather than mere animals.

Among pets, many people raise dogs because dogs are considered highly intelligent and adaptable compared to other pets, and they have an excellent ability to communicate and coexist with their owners. For dogs, daily walks are essential for relieving stress and maintaining health while increasing socialization. When walking a pet such as a dog, the owner may want to dress their pet in clothes or put shoes on the pet to protect the pet from foreign substances on the street and ticks during outings, and to prevent various contaminants from getting on the pet.

However, there is the inconvenience of having to put clothes and shoes on the pet separately, and in particular, the pet's shoes are formed in a straight tube shape to prevent the shoes from coming off, and thus it is very inconvenient to put the pet's legs deep into the shoes so that the pet's feet touch the bottom inside of the shoes.

### DISCLOSURE

### Technical Problem

The present disclosure is intended to solve the above problems occurring in the related art. An objective of the present disclosure is to provide a pet suit that allows the owner to easily put their pet's legs through, making it easy to be put on and taken off, and does not interfere with the pet's movement while walking.

### Technical Solution

In order to achieve the above mentioned objectives, there is provided a pet suit including: a torso suit part configured to wrap a torso of a pet; and a leg suit part which is made of a soft material, which is coupled to the torso suit part, and into which a leg of the pet is inserted, wherein the leg suit part may be constructed by coupling, on a band-shaped fabric, front and rear ends positioned at areas below an ankle joint of the pet to surround a lower portion adjacent to the ankle joint of the pet, and to cover a femoral region of the pet by gradually spreading out from a portion at which the ankle joint of the pet is positioned toward the torso suit part.

In addition, a plurality of leg suit parts may be provided so that each leg of the pet is individually fitted, and each of the leg suit parts may have an upper end thereof detachably connected to the torso suit part.

In addition, the torso suit part may be configured such that a point thereof where the upper end of the each of the leg suit parts is joined is changeable.

In addition, the leg suit part may include: a first leg suit part including: a first joint portion covering both shoulders of the pet; and a first leg receiving portion formed on each side of the first joint portion and into which each foreleg of the pet is inserted; and a second leg suit part including: a second joint portion covering buttocks of the pet; and a second leg receiving portion formed on each side of the second joint portion and into which each hind leg of the pet is inserted, wherein a front end of the first joint portion of the first leg suit part may be connected to the torso suit part, and a rear end of the second joint portion of the second leg suit part may be connected to the torso suit part.

In addition, the first joint portion and the second joint portion may be connected to each other by an elastic band.

### Advantageous Effects

According to the present disclosure, leg suit parts are constructed by coupling, on a band-shaped fabric, front and rear ends positioned at areas below the ankle joints of a pet so as to surround lower portions adjacent to the ankle joints of the pet, and structured to cover the femoral regions of the pet by gradually spreading out from portions at which the ankle joints of the pet are positioned toward a torso suit part, allowing the pet's legs to be easily inserted so that the pet's feet are positioned at the bottom of the leg suit parts. Thus, the user can conveniently put leg suit parts and a torso suit part on and take them off the pet.

### DESCRIPTION OF DRAWINGS

FIG. 1 is an exemplary view showing a state in which a pet wears a pet suit of the present disclosure.

FIG. 2 is a bottom view showing a pet suit according to a first embodiment of the present disclosure.

FIG. 3 is a plan view showing the pet suit according to the first embodiment of the present disclosure.

FIGS. 4 to 6 are views showing examples of a structure for detachably connecting leg suit parts and a torso suit part applied to the pet suit according to the first embodiment of the present disclosure.

FIG. 7 is a bottom view showing a pet suit according to a second embodiment of the present disclosure.

FIG. 8 is a plan view showing the pet suit according to the second embodiment of the present disclosure.

### BEST MODE

In the present disclosure, proposed is a pet suit including: a torso suit part wrapping the torso of a pet so as to be conveniently worn and taken off since the legs of the pet can be easily inserted therein, and to not hinder walking of the pet; and leg suit parts which are made of a soft material, which are coupled to the torso suit part, and into which the legs of the pet are inserted, wherein the leg suit parts are constructed by coupling, on a band-shaped fabric, front and rear ends positioned at areas below the ankle joints of the pet to surround lower portions adjacent to the ankle joints of the pet, and to cover the femoral regions of the pet by gradually spreading out from portions at which the ankle joints of the pet are positioned toward the torso suit part.

The scope of the present disclosure is not limited to the embodiments described below, and various modifications may be made by a person having ordinary knowledge in the relevant technical field without departing from the technical spirit of the present disclosure.

Hereinafter, a pet suit of the present disclosure will be described in detail with reference to the attached drawings 1 to 8.

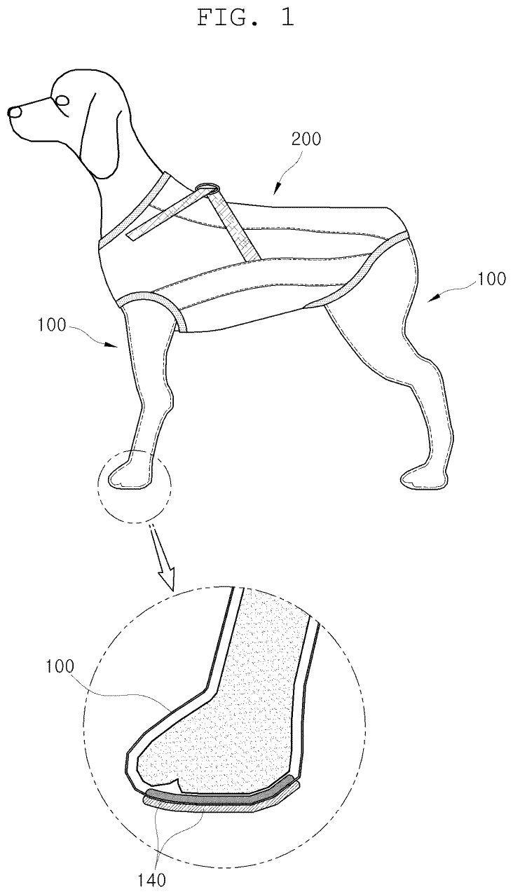

As shown in FIG. 1, a pet suit of the present disclosure includes: a torso suit part 200 that surrounds the body of a pet such as a dog; and leg suit parts 100 that are coupled to the torso suit part 200 and into which the pet's legs fit.

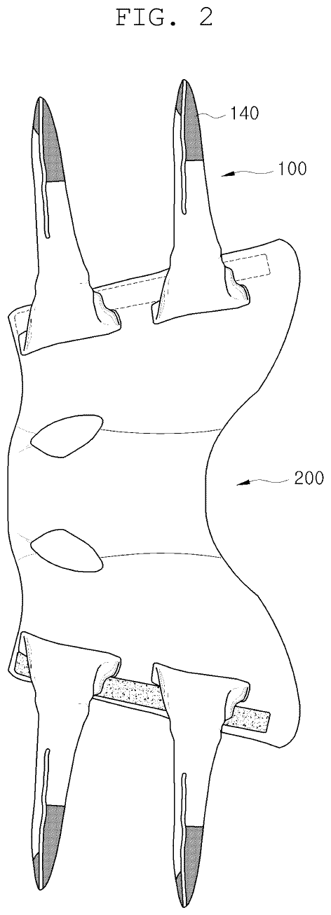

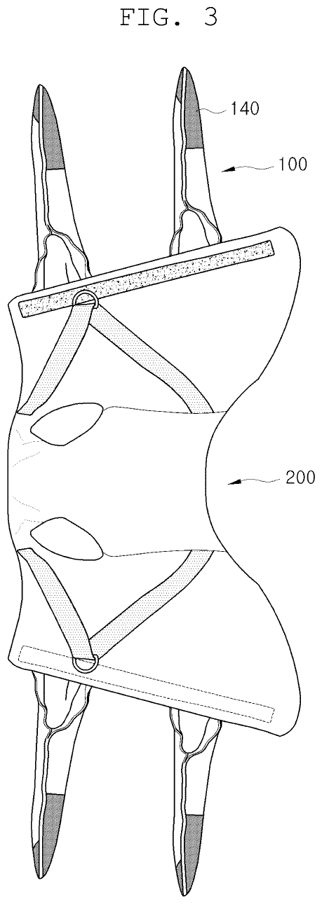

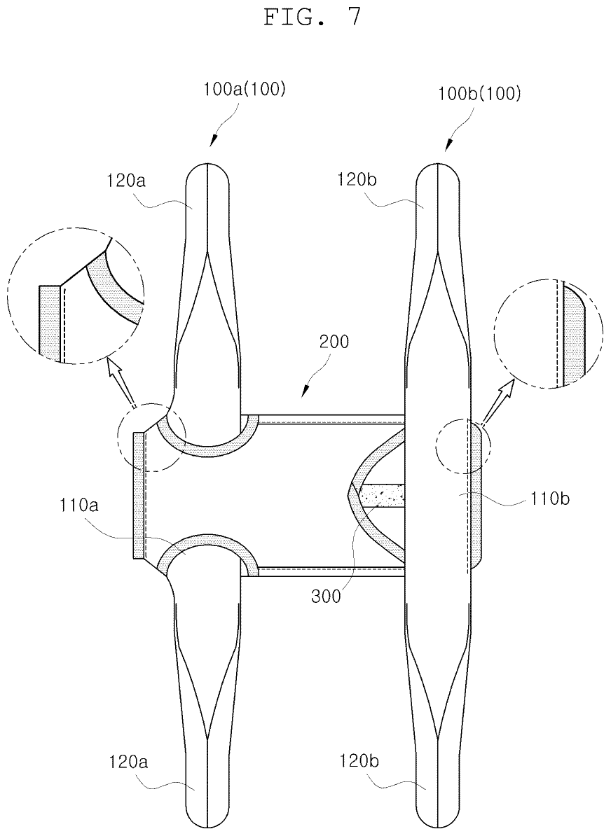

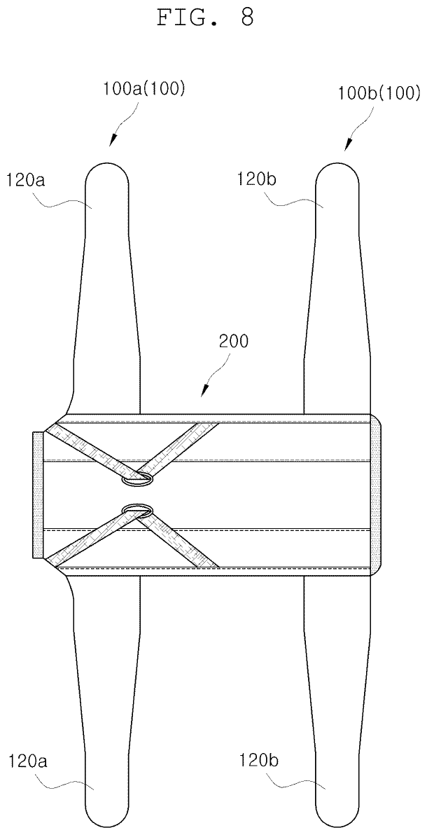

First, the torso suit part 200 may be made of a soft material such as fabric, for example, and may be formed into a tubular shape with open front and rear ends to surround the body of the pet. At this time, as shown in FIGS. 7 and 8, the torso suit part 200 may be worn to surround the body of the pet through an open front or rear end by forming a tubular shape in which the fabric does not spread out. As shown in FIGS. 2 and 3, the torso suit part 200 may also be configured such that the two facing edges in a plate-shaped fabric may be joined to form a tubular shape, but the two joined edges may be separated, so that the suit 200 may be worn while the two edges are separated and spread out, and then the two edges may joined after the suit 200 is worn. In this case, the point where the two edges are joined and separated may be located on the pet's back or stomach when the pet wears the torso suit part 200.

The torso suit part 200 that forms a tubular shape when worn by a pet in this way allows the pet's head and neck to come out through the open front end as shown in FIG. 1, and leg holes may be formed on the bottom surface adjacent to the front end through which the pet's forelegs can exit. In addition, the torso suit part 200 may have a hip hole formed in the rear end bottom through which the hind legs can come out and the lower part of the buttocks can be exposed.

The leg suit parts 100 are made of a soft material such as fabric, coupled to the torso suit part 200, and are a piece that the legs of the pet fit into. In addition, the leg suit parts 100 are preferably made of a material with elasticity, considering that even pets of the same species may have different leg lengths, etc. Accordingly, for example, dogs with different body sizes and leg lengths within a certain range may wear the leg suit parts 100 formed to the same size.

The leg suit parts 100 are designed to cover part of the pet's legs and fit the remaining part of the legs thereinto. As an example, the leg suit parts 100 may be made of fabric in the shape of a band having a predetermined length, and may be constructed by joining the front and rear ends, on the band-shaped fabric, positioned below the ankle joints of the pet as shown in FIGS. 2 to 8. Due to this, the leg suit parts 100 are formed to wrap up to the lower portions adjacent to the ankle joints from the feet of the pet, and to cover the femoral regions of the pet by gradually spreading toward the torso suit part 200 from portions at which the ankle joints of the pet are positioned.

Due to the portion of the leg suit part 100 that is spread out on the upper side of the portion surrounding part of the pet's leg, the leg suit part 100 is connected to the torso suit part 200, but the pet's leg can be easily inserted so that the pet's foot is positioned at the bottom of the leg suit part 100. Thus, the user may conveniently put the leg suit parts 100 and the torso suit part 200 on and take them off the pet.

In addition, the leg suit parts 100 may be formed such that the bottom thereof is open so that the pet's feet are exposed to the outside, but it is preferable that the bottom is sealed to wrap around the sole of the pet's foot so that the leg suit part 100 may also perform the function of a shoe. The lower end of the leg suit part 100 may be provided with an anti-slip member 140 at least on the outer surface or inner surface thereof as shown in FIG. 1, and preferably, the anti-slip member 140 may be provided on both the outer surface and inner surface of the lower end of the leg suit part 100. The anti-slip member 140 provided on the lower outer surface of the leg suit part 100 may increase the frictional force between the ground and the leg suit part 100 to prevent slipping, and the anti-slip member 140 provided on the lower inner surface of the leg suit part 100 may prevent slipping by increasing the friction between the pet and the leg suit part 100.

As a specific first embodiment, as shown in FIGS. 2 to 6, a plurality of leg suit parts 100 may be provided so that each leg of the pet can fit. For dogs, four leg suit parts 100 may be provided so as to be respectively fitted on the forelegs and hind legs. Although the leg suit parts 100 into which the legs of the pet are to be respectively inserted may be sewn to the torso suit part 200 and joined so as not to be separated from the torso suit part 200, considering cases where it is necessary to wear only the torso suit part 200 or where it is difficult to put the leg suit parts 100 on the pet's legs while combined with the torso suit part 200, the leg suit parts 100 are preferably connected to the torso suit part 200 such that each upper part thereof may be separated from the torso suit part 200. In addition, when the leg suit parts 100 are detachably connected to the torso suit part 200, it is preferable that the torso suit part 200 has a structure in which opposite edges of the plate-shaped fabric are detachably connected to each other.

As an example, the torso suit part 200 made of a plate-shaped fabric and having two leg holes formed at the upper part may be configured so that opposite edges may be detachably joined by Velcro, and the opposite edges joined by Velcro are positioned on the pet's back. In addition, the torso suit part 200 in the unfolded state may be configured such that the lower part slopes downward from the center toward the opposite two edges so that when the two edges are joined, the torso suit part 200 covers the upper part of the back and the buttocks, and the hind legs come out downward and the lower part of the buttocks are exposed.

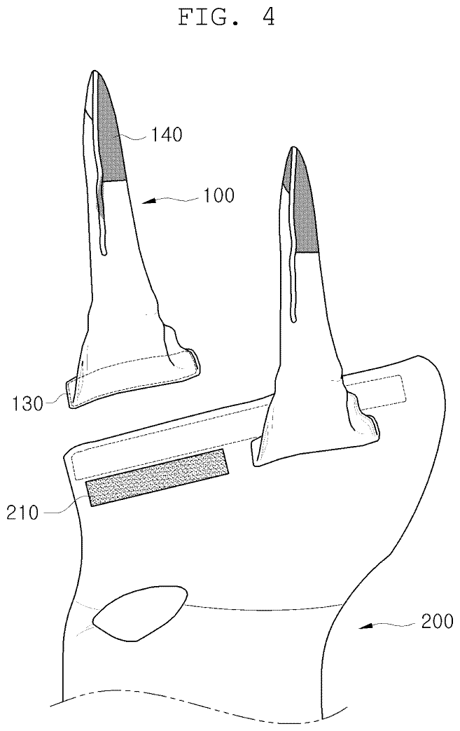

The leg suit parts 100 and the torso suit part 200 formed to be unfoldable in this way may be detachably connected to each other by Velcro as shown in FIGS. 4 to 6, and the upper part of the leg suit parts 100 may be joined to the inner side of the torso suit part 200 that comes into contact with the pet when the torso suit part is provided in a tubular shape. As an example, a first connection portion 130 may be provided on the upper side of the leg suit part 100, and a second connection portion 210 detachably connected to the first connection portion 130 may be provided on the inner side of the torso suit part 200 near opposite edges. At this time, it is desirable that the first connection portion 130 be composed of a male Velcro, and the second connection portion 210 be composed of a female Velcro, so that the pet does not feel uncomfortable due to the second connection portion 210.

In addition, the two leg suit parts 100 into which the forelegs are to be fitted are arranged, in a state of being connected to the inner surface of the torso suit part 200, to face downwards through respective leg holes when the torso suit part 200 is in the tubular shape, and the two leg suit parts 100 into which the hind legs are to be fitted are arranged, in a state of being connected to the inner surface of the torso suit part 200, to face downwards through the hip hole when the torso suit part 200 is in the tubular shape. In this way, the leg suit parts 100, which are detachable from the torso suit part 200, have the upper ends thereof attached to the inner surface of the torso suit part 200 that comes into contact with the pet, and thus the attachment may be prevented from being arbitrarily released due to external factors.

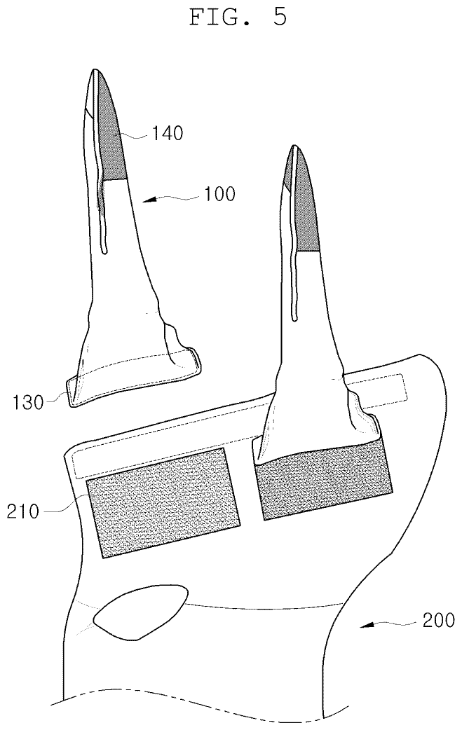

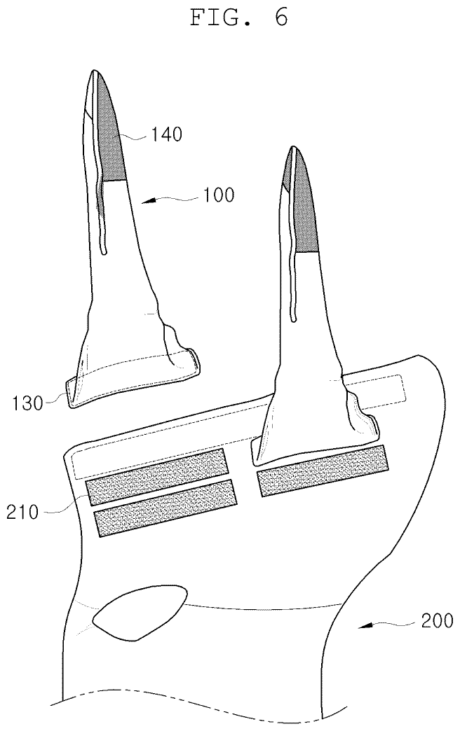

Considering that the body size and leg length may differ depending on the type and breed of the pet, the torso suit part 200 may be configured such that the point thereof where the upper part of the leg suit part 100 is joined may be changed. When the first connection portion 130 is formed in a band shape with a length corresponding to the upper width of the leg suit part 100, as an example, as shown in FIG. 5, the second connection portion 210 is formed to have a width greater than the width of the first connection portion 130, so that the first connection portion 130 may be detachably connected to a portion of the width of the second connection portion 210. As another example, as shown in FIG. 6, the second connection portion 210 may be formed to have a width to the width of the first connection portion 130 and a plurality of second connection portions 210 may be provided spaced apart from each other or adjacent to each other, so that the first connection portion 130 may be detachably connected to any one of the second connection portions 210. Accordingly, the length of the leg suit part 100 may be adjusted to the physical condition of the pet wearing the leg suit part 100.

Meanwhile, as a specific second embodiment, as shown in FIGS. 7 and 8, the leg suit part 100 may include: a first leg suit part 100a configured to fit both forelegs of the pet at once; and a second leg suit part 100b configured to fit both hind legs of the pet at once. The first leg suit part 100a may include: a first joint portion 110a covering both shoulders of the pet; and a first leg receiving portion 120a formed on each side of the first joint portion 110a and into which each foreleg of the pet is inserted. The second leg suit part 100b may include: a second joint portion 110b covering the pet's buttocks; and a second leg receiving portion 120b formed on each side of the second joint portion 110b and into which each hind leg of the pet is inserted. At this time, the first leg receiving portion 120a and the second leg receiving portion 120b have the same structure as the leg suit parts 100 described above, which are configured to cover part of the pet's legs and fit the remaining part of the legs thereinto.

The first leg suit part 100a and the second leg suit part 100b may be used individually, but it is desirable to connect the first leg suit part 100a and the second leg suit part 100b as one piece to prevent loss of either one and to make them easy to wear. As an example, as shown in FIG. 7, the first joint portion 110a and the second joint portion 110b may be connected to each other by an elastic band 300. To be specific, the elastic band 300 may have one end thereof connected to the center of the rear end of the first joint portion 110a and the other end thereof connected to the center of the front end of the second joint portion 110b. Since the elastic band 300 is elastic, even if the distance between the fore and hind legs somewhat varies for each individual pet, both the first leg suit part 100a and the second leg suit part 100b may be worn.

The first leg suit part 100a and the second leg suit part 100b are combined with the torso suit part 200 such that the present disclosure does not interfere with the movement of the pet's legs. To this end, as shown in FIG. 7, the front end of the first joint portion 110a of the first leg suit part 100a may be connected to the front end of the torso suit part 200, and the rear end of the second joint portion 110b of the second leg suit part 100b may be connected to the rear end of the torso suit part 200. To be specific, the first leg suit part 100a is configured such that only the front end of the first joint portion 110a located on the inside of the torso suit part 200 is connected to the front end of the torso suit part 200, and the first leg receiving portion 120a formed on each side of the first joint portion 110a is pulled out through each leg hole. The second leg suit part 100b is configured such that the rear end of the second joint portion 110b is connected to the rear end of the torso suit part 200 while the second joint portion 110b is exposed to the outside through the hip hole, and the second leg receiving portion 120b formed by extending to each of the opposite sides of the second joint portion 110b is also exposed to the outside.

The present disclosure, in which the first leg suit part 100a, the second leg suit part 100b, and the torso suit part 200 are combined as described above, is characterized in that the first leg receiving portions 120a and the second leg receiving portions 120b into which the legs of the pet are inserted are not connected to the torso suit part 200, and the remaining part of the first joint portion 110a except the front end and the remaining part of the second joint portion 110b except the rear end are not connected to the torso suit part 200, so that the pet can move its legs freely while wearing the suit of the present disclosure without interference due to wearing the suit of the present disclosure, and thus the pet can feel comfortable.

### SEQUENCE LIST FREE TEXT

### Description of Reference Numerals

100: leg suit part 100a: first leg suit part
100b: second leg suit part 110a: first joint portion
110b: second joint portion 120a: first leg receiving portion
120b: second leg receiving portion 130: first connection portion
140: anti-slip member
200: torso suit part 210: second connection portion
300: elastic band

1. A pet suit, comprising:
a torso suit part (200) configured to wrap a torso of a pet; and
a leg suit part (100) which is made of a soft material, which is coupled to the torso suit part, and into which a leg of the pet is inserted,
wherein the leg suit part (100) is constructed by coupling, on a band-shaped fabric, front and rear ends positioned at areas below an ankle joint of the pet to surround a lower portion adjacent to the ankle joint of the pet, and to cover a femoral region of the pet by gradually spreading out from a portion at which the ankle joint of the pet is positioned toward the torso suit part (200).

2. The pet suit of claim 1, wherein a plurality of leg suit parts (100) is provided so that each leg of the pet is individually fitted, and
each of the leg suit parts (100) has an upper end thereof detachably connected to the torso suit part (200).

3. The pet suit of claim 2, wherein the torso suit part (200) is configured such that a point thereof where the upper end of the each of the leg suit parts (100) is joined is changeable.

4. The pet suit of claim 1, wherein the leg suit part (100) comprises:
a first leg suit part (100a) comprising: a first joint portion (110a) covering both shoulders of the pet; and a first leg receiving portion (120a) formed on each side of the first joint portion (110a) and into which each foreleg of the pet is inserted; and
a second leg suit part (100b) comprising: a second joint portion (110b) covering buttocks of the pet; and a second leg receiving portion (120b) formed on each side of the second joint portion (110b) and into which each hind leg of the pet is inserted,
wherein a front end of the first joint portion (110a) of the first leg suit part (100a) is connected to the torso suit part (200),
and a rear end of the second joint portion (110b) of the second leg suit part (100b) is connected to the torso suit part (200).

5. The pet suit of claim 4, wherein the first joint portion (110a) and the second joint portion (110b) are connected to each other by an elastic band (300).
